(19) United States
(12) Patent Application Publication
(10) Pub. No.: US 2005/0278777 A1
(43) Pub. Date: Dec. 15, 2005

(54) Method and system for enforcing secure network connection

(75) Inventor: Boris Loza, Richmond Hill (CA)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Hackerproof Security, Inc.

(21) Appl. No.: 11/152,543

(22) Filed: Jun. 14, 2005

Related U.S. Application Data
(60) Provisional application No. 60/578,858, filed on Jun. 14, 2004.

(51) Int. Cl. H04L 9/00; H04L 9/32; G06F 11/30; G06F 12/14

(52) U.S. Cl. 726/4

(57) ABSTRACT

The invention is a system and method for enforcing remote users to use secure network connections. Every time a user connects to the network, its network connection is verified for security vulnerabilities and a security policy applies to every network connection based on the number and severity of security vulnerabilities identified for this particular user on this particular network connection.

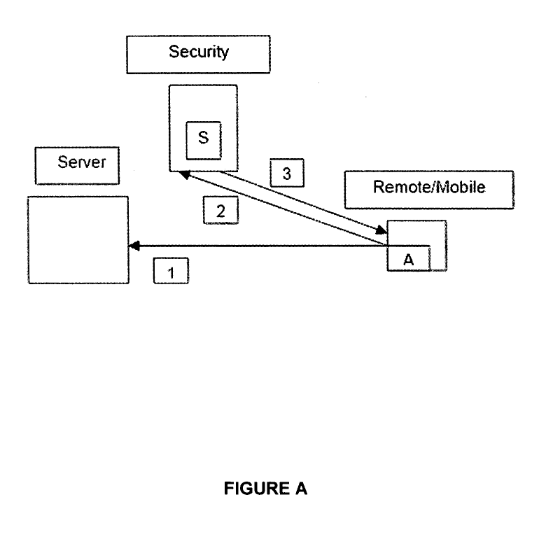

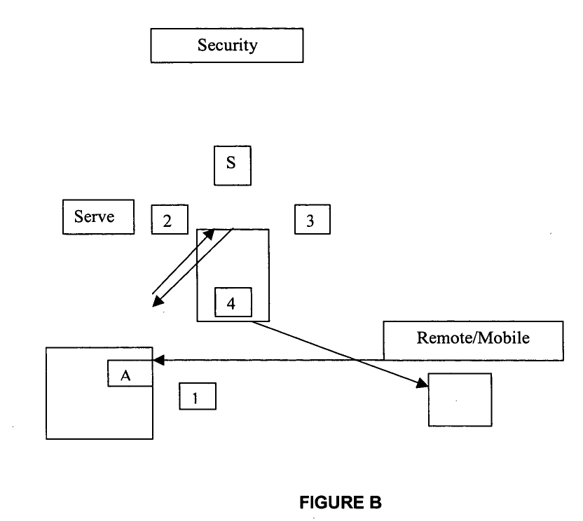

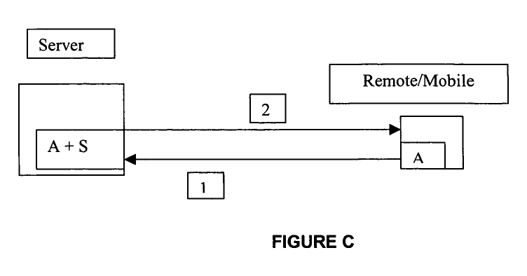

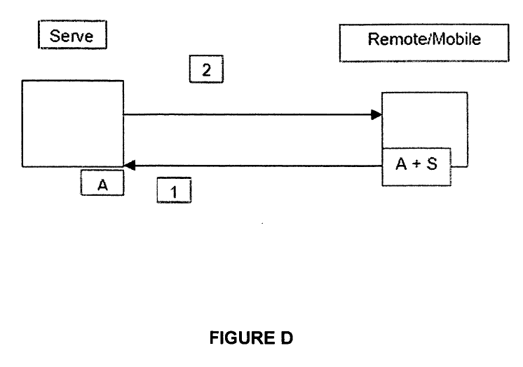

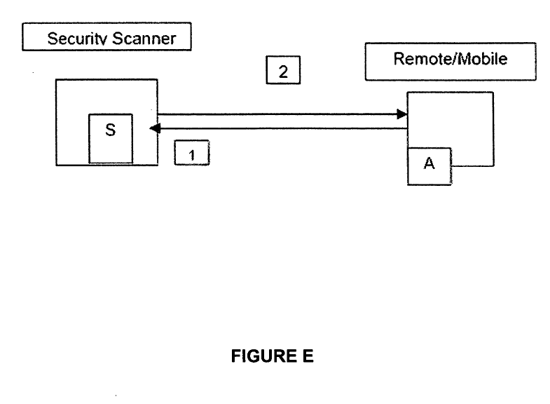

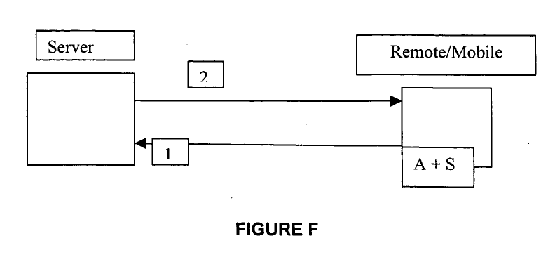

### CROSS-REFERENCE TO RELATED APPLICATION

This application claims priority to copending U.S. provisional application entitled, “Method and System for Enforcing Secure Network Connection,” having Ser. No. 60/578,858, filed Jun. 14, 2004, which is entirely incorporated herein by reference.

### BACKGROUND OF THE INVENTION

In today's mobile office environment many corporations allow their employees to use corporate laptops at home or connect to a corporate VPN from home PCs. The mobile user is likely more susceptible to security vulnerabilities when connected outside the corporate environment than inside since home users don't typically have the expertise required to ensure that their home or mobile connection is as secure as the corporate environment. A vulnerability is a security “hole” in the network that can be used to breach the integrity of the system, or take the system or a service off line (Denial-of-Service), or that may lead to access inappropriate data in the system.

Often the laptops contain highly confidential information including corporate e-mail, user name and passwords databases, documents in progress, and other confidential and proprietary information that could be more easily hacked at the mobile location rather than the corporate environment. For instance, if a laptop or home PC is unprotected from malicious Internet users, it could be compromised and all confidential information and keystrokes will be available for hackers. Once hacked at the mobile environment, the laptop may cause serious security breaches to the corporate network.

This susceptibility can represent very serious security concern because mobile users use the corporate laptop at their home, hotel or mobile location and then bring this laptop, and potential new vulnerabilities, into the corporate environment. A machine compromised from outside the corporate environment can, once brought back within the corporate environment (at an employee's desk, for instance) act somewhat as a Trojan Horse, bringing problems inside the corporate network. This is especially problematic in environments that provide a secure outside firewall and security system but very little once inside the firewall to prevent internal attacks.

In view of PIPEDA, Sarbanes-Oxley and other legislation, the above mentioned problems may create a breach in the security infrastructure and can lead to very serious legal circumstances for a company caught unaware.

### SUMMARY OF THE INVENTION

According to an aspect of the present invention, upon initiation of a network connection between a client device and a server, an external or internal vulnerability detector is automatically requested to scan the network connection for security vulnerabilities. If a vulnerability is detected by the external or internal vulnerability detector, a warning signal is sent to at least one of the server and the client device. Upon receipt of the warning signal, the client device can notify the user of the client device. In addition, the establishment of the network connection can be prevented or cancelled.

According to another aspect of the invention, a system for enforcing secure network connection for remote/mobile users comprises: a network, an agent installed on a machine connected to the Internet/network, network security scanner to assess security on a remote machine connected to the network. Preferably, the agent installed on a machine connected to the network may send a request for initiating security scan on it network connection. The agent installed on a machine initiating the security scan of its network connections, may receive feedback from a security scanner on a number and a severity level of discovered vulnerabilities. The agent installed on a machine may enforce security policy based on the number and the severity level of security vulnerabilities discovered on its network connections.

According to a further aspect of the invention, a system for enforcing secure network connection for remote/mobile users comprises: a network, an agent installed on a machine accepting connections from remote users, network security scanner to assess security on a remote machine connected to the network. The agent installed on a machine that accepts connections from remote users, may send a request to remote network security scanner for initiating security scan on every connected remote user connected. The agent installed on a machine initiating the security scan of remote/mobile users' network connections, may receive feedback from a security scanner on the number and severity of discovered vulnerabilities for every connected remote user. The agent installed on a machine may enforce security policy for every remote user connected to this machine, based on the number and the severity level of security vulnerabilities discovered for every remote user connected to this machine.

According to yet another aspect of the invention, a system for enforcing secure network connection for remote/mobile users comprises: a network, an agent and a security scanner installed on a machine that accepts connections from remote users, and an agent installed on a remote user's machine connected to the network. The network security scanner installed on a machine that accepts connections from remote users may assess network security for every remote user connected to this machine. The agent installed on a machine initiating the security scan of remote/mobile users' network connections, may receive feedback from a built-in security scanner on the number and the severity level of discovered vulnerabilities for every remote user that connects to this machine. The agent installed on a machine may contact an agent installed on a remote user's machine and enforce security policy for every remote user that connects to this machine, based on the number and the severity level of security vulnerabilities discovered for this particular remote user's network connections.

In accordance with another aspect of the invention, a system for enforcing secure network connection for remote/mobile users comprises: a network, an agent installed on a machine connected to the network and accepting connections from remote users, an agent and a network security scanner installed on a remote machine for assessing its own network and connection security. The agent installed on a machine that accepts connections from remote users may request network security scan for every remote user initiated network connection to this machine. The network scanner installed on a remote machine initiating the security scan of this machine own network connections, may receive feedback from its own security scanner on the number and the severity level of discovered vulnerabilities. The agent installed on a remote machine may contact an agent installed on a network server that accepts remote clients' connections and enforce security policy for every remote user that connects to the server, based on the number and severity of security vulnerabilities discovered on this particular remote user's network connections.

In accordance with yet another aspect, the invention provides a system for enforcing secure network connection for remote/mobile users comprising: a network, an agent installed on a machine connected to the network, a network security scanner installed on a remote machine for assessing network security. The agent installed on a machine connected to the Internet/network may request network security assessment of its network connection. The remote network scanner may initiate the security scan of the remote network user. The agent installed on a networked machine that requested security scan may receive feedback from the remote security scanner. This response consists of the number and the severity level of discovered vulnerabilities. The agent installed on a remote machine may enforce security policy for its own network connection, based on the number and the severity level of security vulnerabilities discovered on this particular remote user's network connections.

In accordance with another aspect of the invention a system for enforcing secure network connection for remote/mobile users comprises: a network, an agent and a built-in network security scanner installed on a machine connected to the network. The agent installed on a machine connected to the Internet/network may identify its own external network address. The built-in network scanner may initiate the security scan of the external Internet/network connection for the network user. The agent installed on a networked machine that requested security scan may receive feedback from its own built-in security scanner. This response consists of the number and the severity level of discovered vulnerabilities. The agent installed on a remote machine may enforce security policy for its own Internet/network connection, based on the number and the severity level of security vulnerabilities discovered on this particular remote user's network connections.

In accordance with another aspect, the invention provides a method of providing a warning of an insecure network connection between a client device and a server. The method comprises: receiving a request to detect security vulnerabilities on said client device, said request including a unique identifier of said client device; in response to said request, using said unique identifier to scan said client device for security vulnerabilities; and if at least one security vulnerability is detected, sending a warning message to one of said client device and said server, and sending an instruction message to said client device to implement a particular security measure.

### DETAILED DESCRIPTION

Below are a number of variations based on the theme summarized above, with block diagrams showing the various elements in a network environment:

[image]

1. Remote users connects to a corporate network server (1).

2. Remote user connects to a remote network security scanner (S) and requests a security vulnerabilities scan of its network connection (2).

3. Security scanner assesses remote users' network connectivity and sends a response back to a remote user. The response consists of a number and a severity level of discovered, if any, security vulnerabilities for this particular remote user's network connection (3).

4. Based on a security policy, an agent (A) installed on a remote user's machine may terminate the network connection between a corporate server and a remote user, notify a user that their network connection is insecure, or prevent a user's machine from establishing any network connections.

An example of a security policy is as follows: “if find x vulnerabilities of type y, then shut down the connection. Otherwise, provide warning but don't shut down.” Other examples include “if find any vulnerabilities, shut down the connection”; or “if find any vulnerabilites, shut down the connection and inform user and IT administrator”. As can be seen, a number of security policies can be configured, depending on the nature and/or number of vulnerabilities, the preference of the IT administrator, etc.

[image]

1. Remote user connects to a corporate network server (1).

2. Corporate server connects to a remote network security scanner (S) and requests a security scan on this particular remote user's network connection (2).

3. Scanner starts assessing security of this particular remote user network connection (3).

4. Security sends a response back to the corporate server consisting of a number and a severity level of discovered, if any, security vulnerabilities for this particular remote user's network connection (4).

5. Based on a security policy, an agent (A) installed on a corporate network server may terminate the network connection between the server and a remote user, notify a user that their network connection is insecure, or prevent a user to establish any network connection.

[image]

1. Remote user connects to a corporate network server (1).

2. Corporate server assesses network security of the remote user (2) using server's built-in security scanner (S).

3. Security scanner identifies a number and a severity level of discovered, if any, security vulnerabilities for this particular remote user's network connection.

4. Based on a security policy, an agent (A) installed on a corporate server may terminate the network connection between a server and a remote user, notify a remote user that their network connection is insecure, or prevent user's machine to establish any network connection.

[image]

1. Remote user connects to a corporate network server (1) and determines the IP address of its mobile/remote connection.

2. Network server sends back a response to a remote user consisting of the user's remote/mobile IP address.

3. Remote user starts assessing its own network security using its built-in scanner (S).

4. Built-in security scanner identifies a number and a severity level of discovered, if any, security vulnerabilities for this particular network connection.

5. Based on a security policy, an agent (A) installed on a remote user's machine may terminate the network connection between a network server and a remote user, notify a remote user that their network connection is insecure, or prevent user's machine to establish any network connection.

[image]

[image]

1. Network user connects (1) to remote security scanner (S) and requests a network security assessment.

2. Security scanner assess network security of this particular user (2).

3. Security scanner identifies a number and a severity level of discovered, if any, security network vulnerabilities for this particular user.

4. Based on a security policy, an agent (A) installed on a network user's machine may notify a user that this location from which a user connects to the Internet/network is insecure, or prevent user's machine to establish any network connection.

[image]

1. An agent (A) installed on a machine connected to the Internet/network determines its own external Internet/network IP address by sending a request to a server on the Internet/network (1).

2. Network server responses to a remote machine with this particular network connection external IP address (2).

3. Network connected machine starts assessing security of its own external network connectivity by using its built-in scanner (S).

4. The built-in security scanner identifies a number and a severity level of discovered, if any, security vulnerabilities for this particular machine's external network connection.

5. Based on a security policy, an agent (A) installed on this particular machine that is connected to the Internet/network may notify a user that this particular location that is used to connect to the Internet/network is insecure, or prevent user's machine to establish any network connection.

Method of Identification of Remote Machine

In order to identify its own external IP address, an agent sends an encrypted request containing a random TCP port and a client ID. The client ID will be used on a later stage to send a message to a corporate office (e.g. Remote Access console) about the state of the client's network connection.

The TCP/IP request is simply data that is sent to TCP or UDP ports. Based on the response received, the security scanner can determine if that port is in use and what network service is running behind this port. Using this information the scanner can then focus its checks on the ports that are open and try to identify any weaknesses on these network services.

For example, if the scanner finds that port 143 (the IMAP port) is open, it may proceed to find out what version of IMAP is running on the target machine. If the version is vulnerable, the scanner will use tests that will show if it is possible by an intruder to gain superuser access to the machine using an “exploit” (a program that exploits a security hole).

Alternatives

In a number of situations, a program or agent on the remote user's machine may automatically connect to a security scanner upon the user's attempt to connect to the corporate server. Alternatively, the user may be required to first connect to the security scanner prior to having permission to connect to the corporate network server. The permission may be given by way of a unique key to the remote machine, or a message to the corporate server to accept a connection or another method that would fulfill the function of signalling permission of the remote machine to connect to the corporate system. It should be recognized, however, that with some systems, for instance those offering DHCP, a unique IP address or other identifier is assigned to the remote machine upon connection that could be different each time. In this situation, the above-mentioned client ID would be useful as it would identify the client in a dynamic IP assignment environment.

While the above has been described in general with respect to TCP/IP networks and systems, it would be understood as equally applicable to other types of networks in which security breaches on connections from outside of a particular known network could be a concern.

The above invention could be applied when a remote machine is reconnected to an internal network, whereby the remote machine could request a scan upon reconnection to the network. Alternatively, an internal network server, upon sensing the reconnection of a machine, could trigger a scan of the reconnected machine.

The scan itself is unique from many prior art systems in which a machine may have a number of detectable installed security “patches”, because the prior art systems merely detect a list of the installed patches, but have no provision for determining whether the patches have been configured correctly. The present invention provides an actual scan for known security vulnerabilities upon request, and a means for preventing the connection as per a security policy.

It will be understood that the present invention can also be used as a trigger for informing an IT administrator of the need to properly install security patches on a given remote machine, identified by the client ID.

It will also be understood that the present invention can be used as a trigger to provide a message to a user to download and properly install a particular security measure on the remote machine, as directed by a corporate IT policy etc. This would enable an IT administrator to set a policy, so as to automatically prevent access further into a network until the security measure is installed and working on the remote machine. As such, access to the network would not need to be simply prevented, but conditional upon performance of an action satisfactory to the IT policy. The benefit of this method would be that the IT administrator would not need to manually install the security measure on the machine, but by setting the policy could require it prior to granting access. Once the security measure was installed, the security scanner would reflect the results and access to the rest of the network would be granted.

1. A method of preventing establishment of an insecure network connection between a client device and a server, the method comprising:
detecting an initiation of said network connection;
upon said detecting, automatically initiating an assessment by an external or internal vulnerability detector of security vulnerabilities on said client device; and
if a security vulnerability on said client device is found by said external or internal vulnerability detector, preventing establishment of said network connection.

2. A method of providing a warning of an insecure network connection between a client device and a server, the method comprising:
receiving a request to detect security vulnerabilities on said client device, said request including a unique identifier of said client device;
in response to said request, using said unique identifier to scan said client device for security vulnerabilities; and
if at least one security vulnerability is detected, sending a warning message to at least one of said client device and said server.

3. A method of preventing establishment of an insecure network connection between a client device and a server, the method comprising:
detecting an initiation of said network connection;
upon said detecting, automatically initiating an assessment by an external or internal vulnerability detector of security vulnerabilities on said client device;
receiving a warning message from said external or internal vulnerability detector;
preventing said network connection from being established.
